(19) United States
(12) Patent Application Publication
(10) Pub. No.: US 2022/0177232 A1
(43) Pub. Date: Jun. 9, 2022

(54) MODULAR OMNIDIRECTIONAL HYGIENIC CONVEYOR BELT AND DIRECTIONAL CONTROL SYSTEM

(71) Applicant: CUMBRIA ENTERPRISES, LLC, Kissimmee, FL (US)

(72) Inventors: Nicholas A. Turner, Greeley, CO (US); Richard J. Johnson, Mead, CO (US)

(21) Appl. No.: 17/252,192

(22) PCT Filed: Jun. 30, 2020
(86) PCT No.: PCT/US2020/040237

§ 371 Date: Dec. 14, 2020

(51) Int. Cl. B65G 17/08; B65G 15/32; B65G 23/06

(52) U.S. Cl. CPC B65G 17/083; B65G 2207/26; B65G 23/06; B65G 15/32

(57) ABSTRACT

A modular omnidirectional hygienic conveyor belt constructed of a series of similar conveyor belt modules connected by pivot pins. Each conveyor belt module includes a modular laterally extending body having first spaced apart hinge eyes extending in a first direction and being connected to a first pivot pin and laterally offset second spaced apart hinge eyes extending in an opposed second direction and being connected to a second pivot pin. A plurality of spheres are captured by, engage and rotate omnidirectionally relative to upper and lower arcuate sphere contact surfaces of the body, which define for the spheres openly exposed opposed upper and lower spherical cap regions and openly exposed spherical segment regions therebetween, wherein openings in the body provide access for hygienic cleaning. A directional control system may drive the omnidirectional rotation of the spheres.

### CROSS-REFERENCE TO RELATED APPLICATION

This application claims the benefit of priority of International Patent Application PCT/US20/40237, filed Jun. 30, 2020, the disclosure of which is hereby incorporated by reference in its entirety.

### FIELD OF THE INVENTION

The present disclosure relates generally to conveyor belts used in material handling. More specifically, this application relates to modular conveyor belts having omnidirectional elements that are configured for use in hygienic material handling operations, and directional control of the omnidirectional elements, which may be particularly useful in the food industries.

### BACKGROUND

The material handling industry utilizes conveyor belts of many types to move goods. However, most conveyor belts are not able to be used when moving food products or other items in a hygienic environment, because they are not capable of being sufficiently cleaned. In addition, most conveyor belts provide limited control with respect to movement of goods along the belt, typically simply permitting or providing for forward or rearward movement, such as by rolling on rollers having an axis of rotation or on spheres that permit movement in any direction.

It also may be desired to control movement of the goods in different directions relative to the general direction of movement of the conveyor belt, which may be accomplished by directional control of rollers or spheres from below the conveyor belt. However, such conveyor belts having rollers or spheres tend to encapsulate the rolling elements in a way that does not permit cleaning to the extent necessary for use in hygienic applications and the directional control systems have limited functionality.

In addition, conveyor belts often are constructed in an overly complex way that leads to greater mass or inconvenient assembly, which does not facilitate hygienic cleaning of the conveyor belt. Some conveyor belt structures are designed in a material intensive way wherein each component is able to withstand certain vertical loads, regardless of whether or not they will be exposed to such loads during normal operation. Assemblies using spheres typically block access to a substantial portion of the spheres, which prevents adequate cleaning to be sanitary. Some include sphere holders that slide into a module or upper and lower members that engage each other over large surface areas and without exposing a spherical segment or means of gaining access for cleaning in a hygienic manner.

It is an object of the present disclosure to provide examples of modular omnidirectional conveyor belts that overcome such disadvantages in the prior art.

### SUMMARY

In one aspect, the present disclosure provides a modular omnidirectional hygienic conveyor belt constructed of a series of similar conveyor belt modules that are connected by pivot pins, wherein each conveyor belt module includes a modular laterally extending body having a first plurality of spaced apart hinge eyes extending longitudinally in a first direction to distal ends having laterally extending apertures, a second plurality of spaced apart hinge eyes extending longitudinally in an opposed second direction to distal ends having laterally extending apertures, and wherein the first plurality of spaced apart hinge eyes are laterally offset relative to the second plurality of spaced apart hinge eyes and wherein the apertures of the first plurality of spaced apart hinge eyes are connected to a first pivot pin and the apertures of the second plurality of spaced apart hinge eyes are connected to a second pivot pin. The body further includes a plurality of laterally spaced apart corresponding sets of upper and lower arcuate sphere contact surfaces located between the first plurality of spaced apart hinge eyes and the second plurality of spaced apart hinge eyes, and a plurality of spheres being disposed between the first and second pivot pins, wherein the plurality of spheres are captured by, engage and rotate omnidirectionally relative to the upper and lower arcuate sphere contact surfaces. The plurality of upper and lower arcuate sphere contact surfaces define for the respective plurality of spheres openly exposed opposed upper and lower spherical cap regions and openly exposed spherical segment regions therebetween, wherein openings in the body provide access for hygienic cleaning of the respective body, first and second pivot pins and plurality of spheres.

In a further aspect, the disclosure provides an example modular omnidirectional hygienic conveyor belt wherein the body further includes an upper web having a laterally extending central portion having a plurality of laterally spaced and connected rings including the upper arcuate sphere contact surfaces and upper portions of the first plurality of spaced apart hinge eyes extending longitudinally in the first direction and upper portions of the second plurality of spaced apart hinge eyes extending longitudinally in the opposed second direction, and a lower web having a laterally extending central portion having a plurality of laterally spaced and connected rings including the lower arcuate sphere contact surfaces and lower portions of the first plurality of spaced apart hinge eyes extending longitudinally in the first direction and lower portions of the second plurality of spaced apart hinge eyes extending longitudinally in the opposed second direction. Apertures of the upper portions of the first plurality of spaced apart hinge eyes of the upper web and apertures of the lower portions of the first plurality of spaced apart hinge eyes of the lower web are laterally interleaved and connected to the first pivot pin and apertures of the upper portions of the second plurality of spaced apart hinge eyes of the upper web and apertures of the lower portions of the second plurality of spaced apart hinge eyes of the lower web are laterally interleaved and connected to the second pivot pin. The plurality of laterally spaced and connected rings of the upper web are spaced above the plurality of laterally spaced and connected rings of the lower web and the plurality of spheres are disposed between and engage the upper and lower arcuate sphere contact surfaces and laterally align the plurality of rings of the upper and lower webs.

In another aspect, the disclosure provides an example modular omnidirectional hygienic conveyor belt wherein the body further includes a plurality of laterally spaced U-shaped sphere receiving sockets open in a longitudinal direction with the plurality of U-shaped sphere receiving sockets having upper and lower surfaces with openings therebetween, and including the plurality of laterally spaced apart upper and lower arcuate sphere contact surfaces. The U-shaped sphere receiving sockets receive the plurality of spheres when the U-shaped sphere receiving sockets are temporarily flexed to widen an entry to the plurality of laterally spaced apart upper and lower arcuate sphere contact surfaces. The first pivot pin for each conveyor belt module also serves as a second pivot pin for an adjacent similar conveyor belt module disposed longitudinally in the first direction, such that the second plurality of spaced apart hinge eyes extending longitudinally in an opposed second direction from the body of a similar conveyor belt module are connected to the first pivot pin and are interleaved with the first plurality of spaced apart hinge eyes extending longitudinally in the first direction, and wherein the second pivot pin for each conveyor belt module also serves as a first pivot pin for an adjacent similar conveyor belt module disposed longitudinally in the second direction, such that the first plurality of spaced apart hinge eyes extending longitudinally in an opposed first direction from the body of a similar conveyor belt module are connected to the second pivot pin and are interleaved with the second plurality of spaced apart hinge eyes extending longitudinally in the second direction. The openings between the upper and lower surfaces of the plurality of U-shaped sphere receiving sockets and the plurality of laterally spaced apart upper and lower arcuate sphere contact surfaces of the respective plurality of the U-shaped sphere receiving sockets provide access for the hygienic cleaning of the respective body, first and second pivot pins, and plurality of spheres.

In a further aspect, the disclosure provides a directional control system that may be used with the example modular omnidirectional hygienic conveyor belts to control the direction of the omnidirectional rotation of a selected group of the plurality of spheres. The directional control system includes a drive surface that engages the lower spherical cap regions of the selected group of the plurality of spheres. The drive surface is directionally repositionable and is controlled to move or stop.

The example modular omnidirectional hygienic conveyor belts disclosed herein provide significant advantages over prior conveyor belt assemblies. The components of the example modular conveyor belts, such as the body, first and second pivot pins, and plurality of spheres, may be constructed of one or more plastic materials, such as acetal or polyoxymethylene, which may be known as Delrin®, or other plastics such as polypropylene, polyethylene or the like. Rotatable drive sprockets have drive surfaces that engage driven surfaces located on the conveyor belt modules between the spheres to drive the modular conveyor belt in a first or opposed second direction, such as forward or rearward. The materials for all the components are appropriate for use in systems that may be referred to as hygienic or sanitary. Thus, hygienic or sanitary conveyor belts may be constructed of components that are made by injection molding or other suitable methods of manufacture using suitable plastics. The plastics may provide beneficial smooth, nonporous, non-absorbent surfaces that tend to be chemically resistant, easy to clean, do not require lubrication, provide long life and reduce the risk of contamination. Additionally, very few different components are needed, reducing complexity of manufacturing while promoting higher quality.

The unique example configurations take advantage of simplified, light weight assemblies that may rely on integral use of the plurality of freely rotating spheres to help support and align the vertical and lateral structure of the body of the modular conveyor belt. The goods being handled generally engage the upper spherical cap regions and typically will not tend to contact or vertically load the top surface of the body. As disclosed herein, the bodies of the modular conveyor belts may be constructed of one or more pieces. The assemblies also avoid the need for fasteners by utilizing a coordinated assembly sequence that captures the spheres prior to completing insertion of the pivot pins.

Having food products or other goods engage the upper spherical cap regions of the plurality of spheres permits easy manipulation of the products or goods. A selected region of the modular conveyor belt may be utilized to provide directional control of the products or goods by engaging the lower spherical cap regions of a selected group of the plurality of spheres in the selected region of the modular conveyor belt to actively rotate the spheres in a preferred direction to drive the products or goods that are engaging the upper spherical caps, or to stop movement. Thus, any product that engages the spheres may be moved, directed or stopped in place with very little effort while the spheres provide movement with very low friction. The modular conveyor belt may be employed in any length and width desired and may run in a straight continuous configuration, whether level, inclined, declined or through twisted sections, as required in the specific implementation.

The modular conveyor belts may be scaled for use with different products and may be of any suitable size. As an example, solid acetal spheres having a diameter of 0.75 inches may be used while providing slots or openings within the body of the modular conveyor belt that provide adequate access to flush away debris and cleaning fluids. A series of modular conveyor belt bodies are connected by the pivot pins in an interleaved pattern to form a continuous conveyor belt. Nevertheless, the openings provided within the modular conveyor belt help to avoid entrapping material that would promote bacterial growth, and advantageously facilitate cleaning. The 0.75 inch diameter spheres may, for example, be used in modular conveyor belt bodies configured to have the spherical cap regions extend approximately 0.125 inches above and below the upper and lower surfaces of the body, while also openly exposing a spherical segment having a height of approximately 0.166 inches between the upper and lower arcuate sphere contact surfaces of the body for convenient and thorough cleaning. It will be appreciated that just as the sizes of the bodies, spheres and pivot pins may be selected as desired, so too may be the sizes of the respective openings and the heights of the openly exposed upper and lower spherical cap regions and spherical segment region of each sphere.

As noted above and explained further in the present disclosure, the example modular conveyor belts and methods of making and driving the same provide several advantages over the prior art. It also is to be understood that both the foregoing general description and the following detailed description are exemplary and provided for purposes of explanation only. They are not restrictive of the claimed subject matter. Further features and objects of the present disclosure will become more fully apparent in the following description of the preferred embodiments and from the appended claims.

### BRIEF DESCRIPTION OF DRAWINGS

In describing the preferred embodiments, references are made to the accompanying drawing figures wherein like parts have like reference numerals, and wherein:

FIG. 1 is an upper front perspective view of a first example conveyor belt module of a modular omnidirectional hygienic conveyor belt.

FIG. 2 is a lower rear perspective view of the example shown in FIG. 1.

FIG. 3 is an upper rear perspective exploded view of the example shown in FIGS. 1 and 2.

FIG. 4 is a rear view of the example shown in FIG. 1, without the near pivot pin installed.

FIG. 5 is an upper rear perspective view of a portion of a modular omnidirectional hygienic conveyor belt having three connected conveyor belt modules of the example shown in FIG. 1.

FIG. 6 is a top view of the portion shown in FIG. 5.

FIG. 7 is an upper perspective partial cross-sectional view of the portion shown in FIG. 5 engaged by a drive sprocket.

FIG. 8a is an upper rear perspective view of the portion shown in FIG. 5 engaged by a directional control system parallel to the modular conveyor belt.

FIG. 8b is a top simplified perspective view of a portion of a modular omnidirectional hygienic conveyor belt with a selected group of the spheres engaged by a directional control system that is pivotal and shown in a position at an angle to the modular conveyor belt.

FIG. 9 is an upper rear perspective view of a second example conveyor belt module of a modular omnidirectional hygienic conveyor belt.

FIG. 10 is a lower rear perspective view of the example shown in FIG. 9.

FIG. 11 is a top view of the example shown in FIG. 9.

FIG. 12 is a rear view of the example shown in FIG. 9.

FIG. 13 is an upper front perspective view of the body of the second example conveyor belt module shown in FIG. 9.

FIG. 14 is an upper rear perspective view of the body shown in FIG. 13.

FIG. 15 is an upper perspective view of the body and spheres shown in FIG. 9 prior to downward insertion of the spheres into an intermediate location in the body.

FIG. 16 is a top view of the body and spheres shown in FIG. 15 with the U-shaped sphere receiving sockets temporarily flexed outward, while the spheres are in the intermediate location that widens the entries for the spheres.

FIG. 17 is an upper rear perspective view of a portion of a modular omnidirectional hygienic conveyor belt having two connected conveyor belt modules of the example shown in FIG. 9.

FIG. 18 is a top view of the portion shown in FIG. 17.

It should be understood that the drawings are not necessarily to scale. While some details of the example modular conveyor belts, including potential alternative configurations and other plan and section views of the particular components have not been shown, such details are considered to be within the comprehension of those of skill in the art in light of the present disclosure. It also should be understood that the present disclosure and claims are not limited to the example preferred embodiments illustrated.

### DETAILED DESCRIPTION OF THE PREFERRED EMBODIMENTS

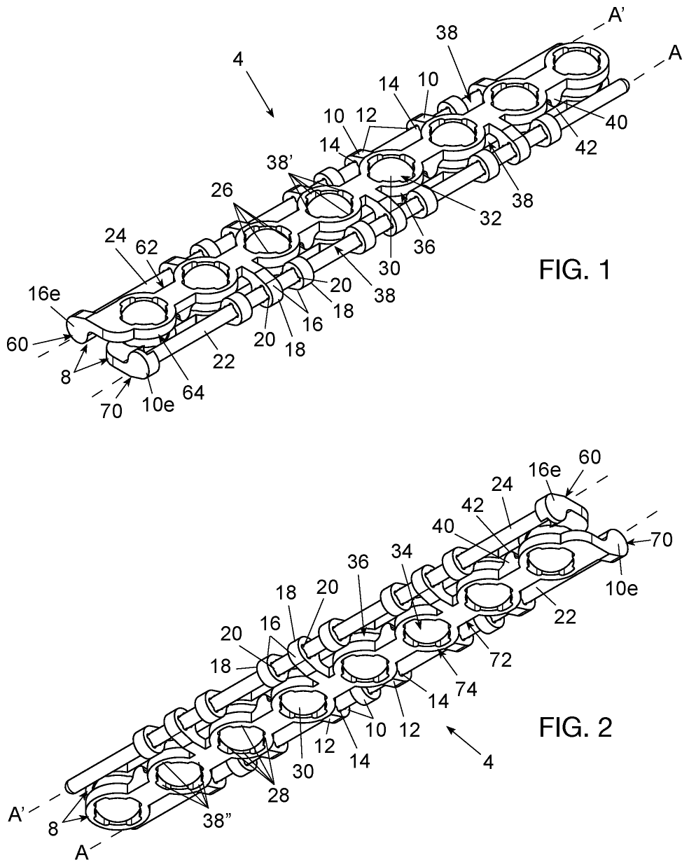

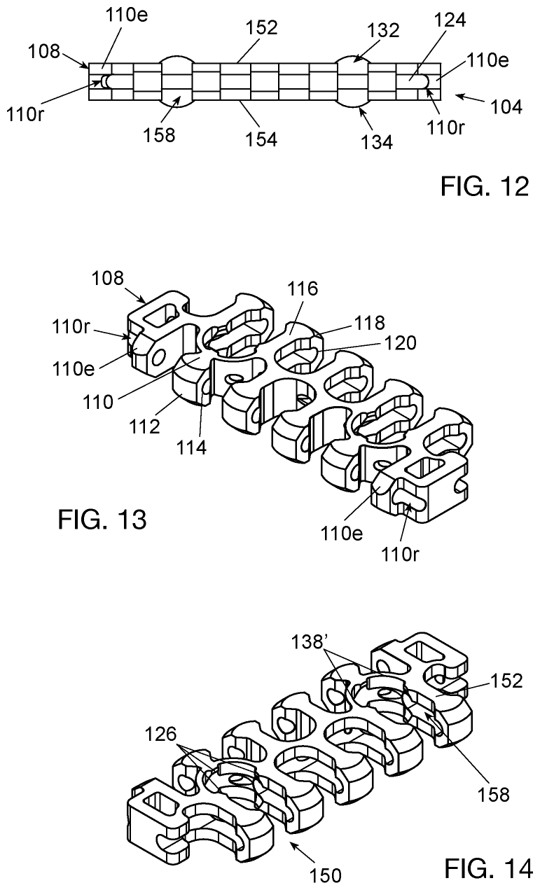

Turning to FIGS. 1-18, two example modular omnidirectional hygienic conveyor belts are shown, along with a directional control system that is repositionable and may rotatably drive a selected group of the omnidirectional spheres. The first example modular omnidirectional hygienic conveyor belt shown in FIGS. 1-8c includes a two-portion body, while the second example modular omnidirectional hygienic conveyor belt includes a single-portion body.

FIGS. 1-8c relate to a first example conveyor belt module 4 of a modular omnidirectional hygienic conveyor belt that would be constructed of a series of similar conveyor belt modules 4 that are connected by pivot pins. As may be seen in FIGS. 1-4, each conveyor belt module 4 includes a modular laterally extending body 8 having a first plurality of spaced apart hinge eyes 10 extending longitudinally in a first direction, such as forward, to distal ends 12 having laterally extending apertures 14. The conveyor belt module 4 includes a second plurality of spaced apart hinge eyes 16 extending longitudinally in an opposed second direction, such as rearward, to distal ends 18 having laterally extending apertures 20. The first plurality of spaced apart hinge eyes 10 are laterally offset relative to the second plurality of spaced apart hinge eyes 16 and the apertures 14 of the first plurality of spaced apart hinge eyes 10 are connected to a first pivot pin 22 and the apertures 20 of the second plurality of spaced apart hinge eyes 16 are connected to a second pivot pin 24. Each of the apertures 14, 20 include channels 14c, 20c that permit cleaning and drainage. The conveyor belt body 8 further includes a plurality of laterally spaced apart corresponding sets of upper arcuate sphere contact surfaces 26 and lower arcuate sphere contact surfaces 28 located between the first plurality of spaced apart hinge eyes 10 and the second plurality of spaced apart hinge eyes 16.

A plurality of spheres 30 are disposed between the first and second pivot pins 22, 24, wherein the plurality of spheres 30 are captured by, engage and rotate omnidirectionally relative to the upper and lower arcuate sphere contact surfaces 26, 28. The plurality of upper and lower arcuate sphere contact surfaces 26, 28 define for the respective plurality of spheres 30 openly exposed opposed upper spherical cap regions 32 and lower spherical cap regions 34 and openly exposed spherical segment regions 36 therebetween, wherein openings 38 in the body 8 provide access for hygienic cleaning of the respective body 8, first and second pivot pins 22, 24, and plurality of spheres 30.

Each of the plurality of sets of the upper arcuate sphere contact surfaces 26 is circumferentially spaced apart and defines openings 38′ therebetween and each of the corresponding plurality of sets of the lower arcuate sphere contact surfaces 28 is circumferentially spaced apart and defines openings 38″ therebetween. The openings 38, 38′, 38″ help facilitate cleaning of the plurality of spheres 30 and surfaces within the body 8 around the spheres 30.

The first pivot pin 22 has an axis A and the second pivot pin 24 has an axis A′ that is parallel to the axis A of the first pivot pin 22. The first pivot pin 22 is rotatably connected to the first plurality of spaced apart hinge eyes 10. The second pivot pin 24 is rotatably connected to the second plurality of spaced apart hinge eyes 16. The body 8 includes end most hinge eyes 10e, 16e at one end that have recesses 10r, 16r, each of which captures and blocks lateral movement of one of the pivot pins 22, 24. Each of the recesses 10r, 16r include channels 10rc, 16rc that permit cleaning and drainage.

The body 8, first and second pivot pins 22, 24, and plurality of spheres 30 of the modular omnidirectional hygienic conveyor belt are constructed of one or more plastic materials. The one or more plastic materials may include acetal or polyoxymethylene, polypropylene, polyethylene or other suitable plastics usable for construction of hygienic equipment.

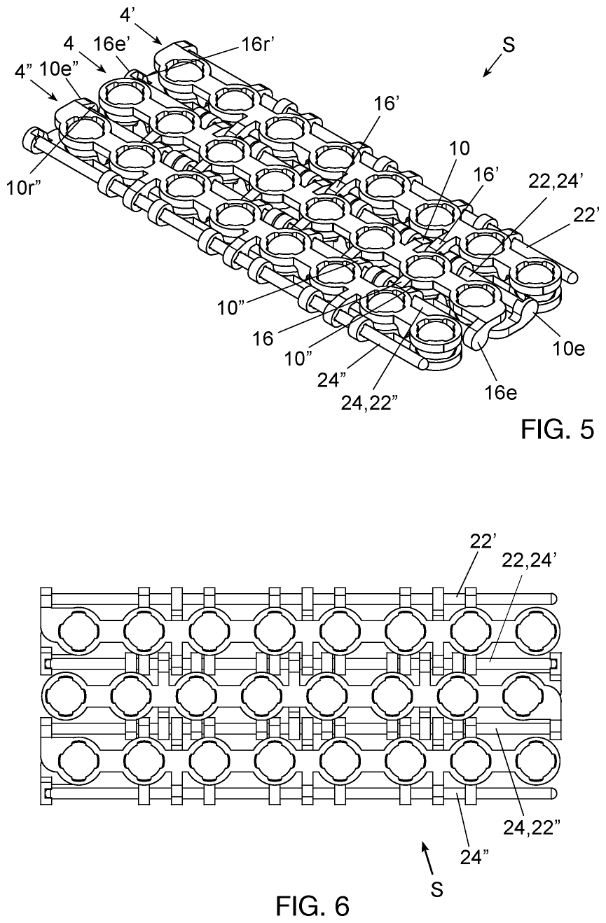

It is to be understood that the modular omnidirectional hygienic conveyor belt includes a series of connected similar conveyor belt modules 4. Larger three module sections S of a modular omnidirectional hygienic conveyor belt are shown, for example, in FIGS. 5-8c. In this example, the first pivot pin 22 for each conveyor belt module 4 also serves as a second pivot pin 24′ for an adjacent similar conveyor belt module 4′ disposed longitudinally in the first direction and the second pivot pin 24 for the conveyor belt module 4 also serves as a first pivot pin 22′ for an adjacent similar conveyor belt module 4″ disposed longitudinally in the second direction. The plurality of spaced apart hinge eyes 16′ (extending in the second direction) of the respective adjacent similar conveyor belt module 4′ are interleaved with the plurality of spaced apart hinge eyes 10 (extending in the first direction) of the conveyor belt module 4 that are connected to a common pivot pin, which in this case is first pivot pin 22 for the conveyor belt module 4 and is the second pivot pin 24′ for the adjacent similar conveyor belt module 4′. Similarly, the plurality of spaced apart hinge eyes 16 (extending in the second direction) of the conveyor belt module 4 are interleaved with the plurality of spaced apart hinge eyes 10″ of the respective adjacent similar conveyor belt module 4″ that are connected to a common pivot pin, which in this case is second pivot pin 24 for the conveyor belt module 4 and is the first pivot pin 22″ for the adjacent similar conveyor belt module 4″.

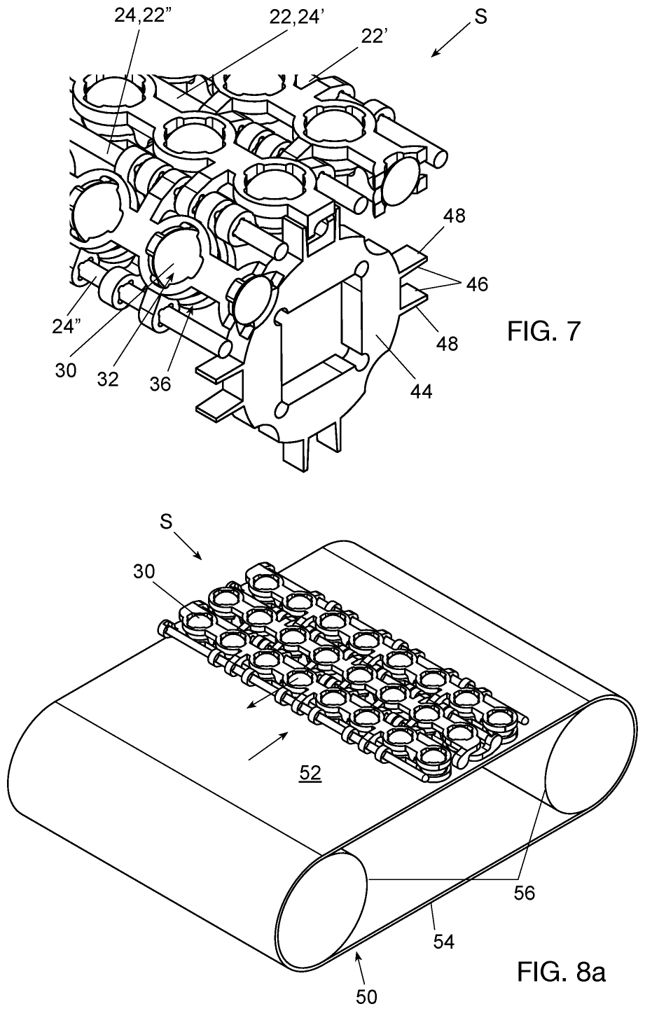

With respect to driving the modular omnidirectional hygienic conveyor belt, FIGS. 2 and 7 show the body 8 further includes driven surfaces 40 located between the plurality of sets of laterally spaced apart upper and lower arcuate sphere contact surfaces 26, 28. In this example, the driven surfaces 40 are located on vertical stops 42, which prevent excessive vertical compression on the plurality of spheres 30. The modular omnidirectional hygienic conveyor belt is used in combination with a plurality of rotatable sprockets 44 having drive surfaces 46 that engage the driven surfaces 40 located on the conveyor belt modules 4 between the spheres 30 to move the belt in the first direction or the opposed second direction. The plurality of rotatable drive sprockets 44 have the drive surfaces 46 on projections 48 that are positioned to engage the driven surfaces 40 on the bodies 8 of the conveyor belt modules 4.

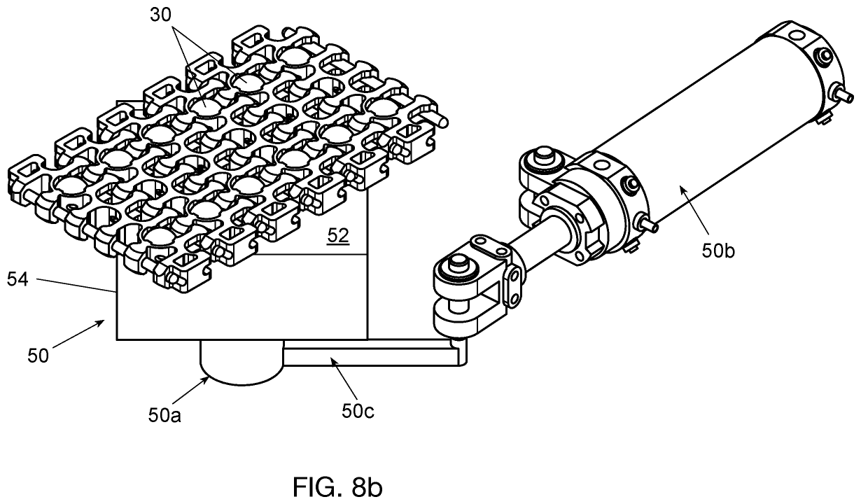

In addition, as seen in FIGS. 8a and 8b, the modular omnidirectional hygienic conveyor belt optionally facilitates directional control of the omnidirectional rotation of the spheres 30 by engaging the lower spherical cap regions 34, which may be seen in FIGS. 2 and 4. This may be achieved via use of a directional control system 50 that may drive the omnidirectional rotation of a selected group of the plurality of spheres 30. Such control may be used to change the movement of products or goods traveling over the modular conveyor belt, such as to stop the products or redirect the products to move relatively longitudinally or laterally, by for example, using a controlled drive surface 52 to engage the lower spherical cap regions 34 of the selected group of the plurality of spheres 30, which ultimately impacts the rotation of the spheres 30, and in turn the goods moving over the upper spherical cap regions 32, which may be seen in FIGS. 1 and 4, of the selected group of the plurality of spheres 30. In this example, shown in simplified form for ease of viewing, the controlled drive surface 52 is shown as a drive belt 54 running on parallel rollers 56, at least one of which is driven, such as by an electric motor. In turn, the directional control system 50 is repositionable. For example, the directional control system 50 may be supported by a pivotal carriage 50a, which permits directional changes, such as are represented in FIG. 8a, with the controlled drive surface 52 parallel to the modular conveyor belt, relative to FIG. 8b, with the controlled surface 52 at an acute angle to the modular conveyor belt. The pivotal carriage 50a is shown in simplified form to more easily see that it may be selectively pivoted by actuation of a control device 50b, such as is shown in the form of a hydraulic actuator. The control device 50b is pivotally connected to a link 50c at a first end, with the second end of the link 50c being connected to the pivotal carriage 50a. It will be appreciated that the pivotal carriage 50a would support the drive surface 52 and the apparatus that moves the drive surface 52, such as the parallel rollers 56 and a drive motor that rotates the rollers. Thus, the drive surface 52 may be continuously controlled to stop, drive forward or rearward, and further directionally control rotation of the spheres, in line or at an angle to the direction of travel of the modular conveyor belt.

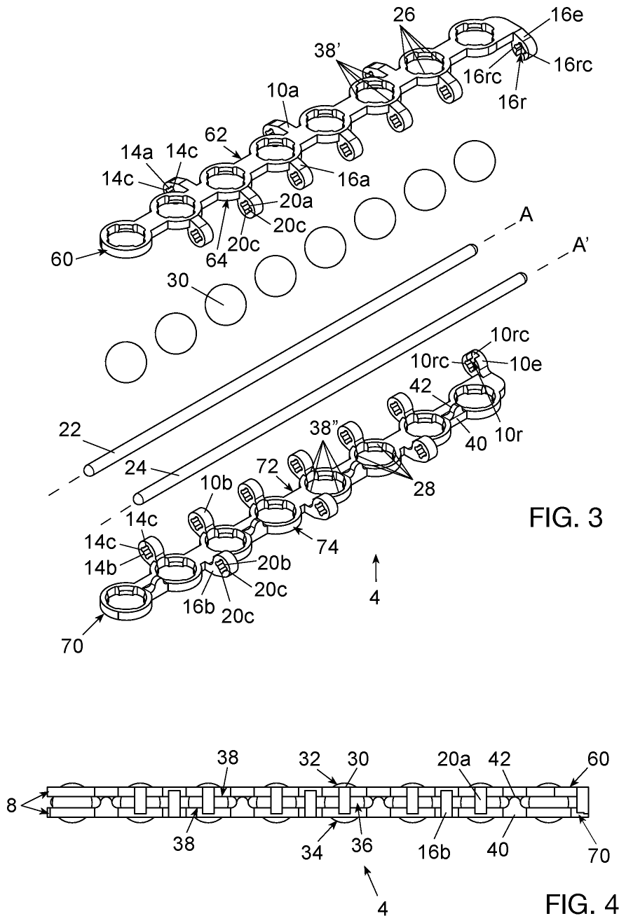

An example conveyor belt module 4 of the first example modular omnidirectional hygienic conveyor belt can be described in further detail with respect to having a multi-piece body 8, which is seen in the first example shown in FIGS. 1-8c. In the first example, as may be seen in FIG. 3, the body 8 includes an upper web 60 having a laterally extending central portion 62 having a plurality of laterally spaced and connected rings 64 including the upper arcuate sphere contact surfaces 26 and upper portions 10a of the first plurality of spaced apart hinge eyes 10 extending longitudinally in the first direction and upper portions 16a of the second plurality of spaced apart hinge eyes 16 extending longitudinally in the opposed second direction, and a lower web 70 having a laterally extending central portion 72 having a plurality of laterally spaced and connected rings 74 including the lower arcuate sphere contact surfaces 28 and lower portions 10b of the first plurality of spaced apart hinge eyes 10 extending longitudinally in the first direction and lower portions 16b of the second plurality of spaced apart hinge eyes 16 extending longitudinally in the opposed second direction. It will be appreciated that while the rings 64, 74 need not necessarily be circular, they must include the upper and lower arcuate sphere contact surfaces 26, 28, which engage the spheres 30 and permit omnidirectional rotation relative thereto.

Apertures 14a of the upper portions 10a of the first plurality of spaced apart hinge eyes 10 of the upper web 60 and the apertures 14b of the lower portions 10b of the first plurality of spaced apart hinge eyes 10 of the lower web 70 are laterally interleaved and connected to the first pivot pin 22. The apertures 14a, 14b of the first example advantageously include channels 14c to facilitate cleaning and drainage. Apertures 20a of the upper portions of the second plurality of spaced apart hinge eyes 16 of the upper web 60 and the apertures 20b of the lower portions 16b of the second plurality of spaced apart hinge eyes 16 of the lower web 70 are laterally interleaved and connected to the second pivot pin 24. The apertures 20a, 20b similarly include advantageous channels 20c.

With this first example, it will be appreciated that in a particularly advantageous configuration the same web structure may be used in a first piece as the upper web 60 and in a similar second piece as the lower web 70. Thus, the upper web 60 is disposed in a first orientation and a similar web structure is provided as the lower web 70 in a second upside-down orientation relatives to the upper web 60. As such, the body 8 includes an end most hinge eye 10e extending from the lower web 70, which acts to capture and block lateral movement of the pivot pin 22 in a recess 10r in at least one direction. Similarly, the body 8 includes an end most hinge eye 16e extending from the upper web 60, which acts to capture and block lateral movement of the pivot pin 24 in a recess 16r in at least one direction.

It will be appreciated in FIGS. 5 and 6 that because the pivot pins are shared by adjacent conveyor belt modules, the pivot pins 22, 24 for conveyor belt module 4 are captured and lateral movement blocked in the opposite direction by similar end most hinge eyes 16e′ and 10e″ provided by the adjacent similar conveyor belt modules 4′ and 4″. For purposes of installation, it will be appreciated that the pivot pins 22, 24 may be flexed slightly to slip past an end most hinge eye while being inserted, so as to then have the end of the pivot pin received in a recess 10r″, 16r′ within the respective end most hinge eye. As previously described, the end most hinge eyes also may include channels to facilitate cleaning. It also will be appreciated that the ability to construct each body 8, 8′, 8″ from two identical webs that simply are used in different orientations such that the end most hinge eyes capture and block each end of each pivot pin relative to lateral movement is highly advantageous with respect to cost, material efficiency, simplicity of manufacture and efficient stocking of components.

The plurality of laterally spaced and connected rings 64 of the upper web 60 are spaced above the plurality of laterally spaced and connected rings 74 of the lower web 70. The plurality of spheres 30 are disposed between and engage the upper and lower arcuate sphere contact surfaces 26, 28 and laterally align the plurality of rings 64, 74 of the upper and lower webs 60, 70. Stops 42 extend from the central portions 62, 72 to ensure that the spheres 30 will not be subjected to compression by the upper and lower arcuate sphere contact surfaces 26, 28. Thus, the upper and lower webs may include vertical stops 42 that limit relative movement of the upper and lower webs 60, 70 toward each other. As previously noted, the stops 42 additionally may serve the function of being the driven surfaces 40 that are engaged by the drive surfaces 46 on the projections 48 of the drive sprockets 44.

It will be appreciated that the spheres 30 also will provide some integral support of the upper web 60 relative to the lower web 70. This is due to the engagement of the spheres 30 with the upper and lower arcuate sphere contact surfaces 26, 28 of the respective plurality of rings 64, 74 of the upper and lower webs 60, 70. The stops 42 ensure that the spheres 30 do not get compressed by the upper and lower webs 60, 70 and remain rotatable. It also will be appreciated from the drawings and foregoing description that the modular conveyor belt may be configured to run in a straight longitudinal orientation and can be inclined, declined and twisted as needed.

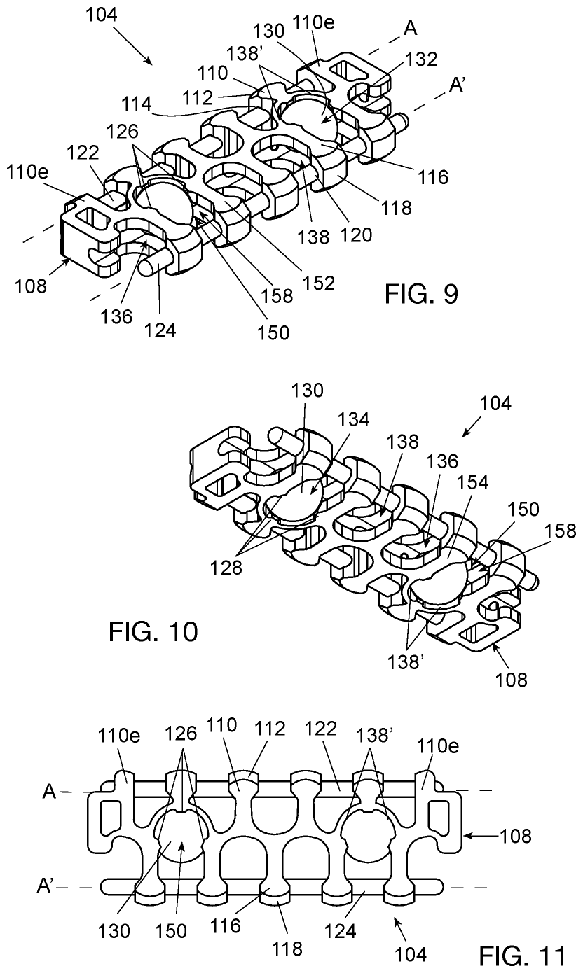

The second example modular omnidirectional hygienic conveyor belt shown in FIGS. 9-18 may be described similarly to the initial description above regarding the first example shown in FIGS. 1-8c. However, for clarity, the second example will first be described in a similar manner using corresponding reference numbers, and then will be described in further detail.

FIGS. 9-18 show the second example conveyor belt module 104 of a modular omnidirectional hygienic conveyor belt that would be constructed of a series of similar conveyor belt modules 104 that are connected by pivot pins. Each conveyor belt module 104 includes a modular laterally extending body 108 having a first plurality of spaced apart hinge eyes 110 extending longitudinally in a first direction, such as forward, to distal ends 112 having laterally extending apertures 114. The conveyor belt module 104 includes a second plurality of spaced apart hinge eyes 116 extending longitudinally in an opposed second direction, such as rearward, to distal ends 118 having laterally extending apertures 120. The first plurality of spaced apart hinge eyes 110 are laterally offset relative to the second plurality of spaced apart hinge eyes 116. The apertures 114 of the first plurality of spaced apart hinge eyes 110 are connected to a first pivot pin 122 having an axis A and the apertures 120 of the second plurality of spaced apart hinge eyes 116 are connected to a second pivot pin 124 having an axis A′. The conveyor belt body 108 further includes a plurality of laterally spaced apart upper arcuate sphere contact surfaces 126 and lower arcuate sphere contact surfaces 128 located between the first plurality of spaced apart hinge eyes 110 and the second plurality of spaced apart hinge eyes 116.

A plurality of spheres 130 are disposed between the first and second pivot pins 122, 124, wherein the plurality of spheres 130 are captured by, engage and rotate omnidirectionally relative to the upper and lower arcuate sphere contact surfaces 126, 128. The plurality of upper and lower arcuate sphere contact surfaces 126, 128 define for the respective plurality of spheres 130 openly exposed opposed upper spherical cap regions 132 and lower spherical cap regions 134 and openly exposed spherical segment regions 136 therebetween, wherein openings 138 in the body 108 provide access for hygienic cleaning of the respective body 108, first and second pivot pins 122, 124, and plurality of spheres 130. In addition, each of the plurality of sets of the upper arcuate sphere contact surfaces 126 is circumferentially spaced apart and defines openings 138′ therebetween and each of the corresponding plurality of sets of the lower arcuate sphere contact surfaces 128 is circumferentially spaced apart and defines openings 138″ therebetween. The openings 138′ and 138″ also help facilitate cleaning of the plurality of spheres 130 and surfaces within the body 108 around the spheres 130.

The second example conveyor belt modules 104 may be assembled into a modular omnidirectional hygienic conveyor belt having similar features and advantages to those described above with respect to the first example.

An example conveyor belt module 104 of the second example modular omnidirectional hygienic conveyor belt can be described in further detail with respect to its single-piece body 108. The body 108 of the second example conveyor belt module 104 includes a plurality of laterally spaced U-shaped sphere receiving sockets 150 open in a longitudinal direction. The plurality of U-shaped sphere receiving sockets 150 have upper and lower surfaces 152, 154 with openings 158 therebetween, and include the plurality of laterally spaced apart upper and lower arcuate sphere contact surfaces 126, 128.

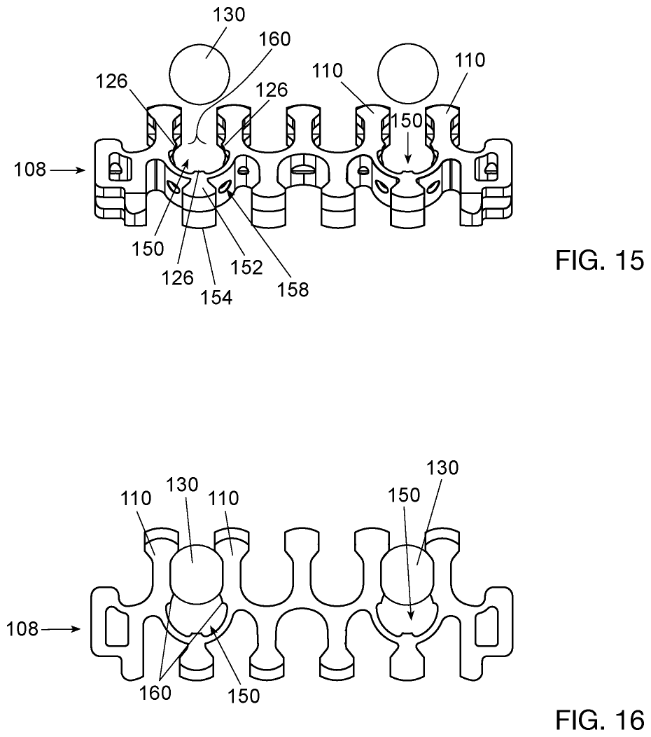

As may be appreciated in FIG. 16, the U-shaped sphere receiving sockets 150 receive the plurality of spheres 130 when the U-shaped sphere receiving sockets 150 have to be temporarily flexed to widen an entry 160 to the plurality of laterally spaced apart upper and lower arcuate sphere contact surfaces 126, 128. Thus, each of the plurality of spheres 130 may be pushed into an intermediate position shown in FIG. 16 from above (as in FIG. 15) or below the body 108, and ultimately is pushed longitudinally parallel to the body 108, past the entry 160 and into position between the upper and lower arcuate sphere contact surfaces 126, 128 within the U-shaped sphere receiving socket 150. The hinge eyes 110 of the body 108 then may spring back to their original position at rest, as may be seen in FIGS. 9-11 (and 13-14), wherein the plurality of spheres 130 are captured for omnidirectional rotation.

The first pivot pin 122 for each conveyor belt module 104 also serves as a second pivot pin 124′ for an adjacent similar conveyor belt module (not shown) disposed longitudinally in the first direction, such that the second plurality of spaced apart hinge eyes extending longitudinally in an opposed second direction from the body of a similar conveyor belt module are connected to the first pivot pin 122 and are interleaved with the first plurality of spaced apart hinge eyes 110 extending longitudinally in the first direction. The second pivot pin 124 for each conveyor belt module 104 also serves as a first pivot pin 122″ for an adjacent similar conveyor belt module 104″ disposed longitudinally in the second direction, such that the first plurality of spaced apart hinge eyes 110″ extending longitudinally in an opposed first direction from the body 108″ of a similar conveyor belt module 104″ are connected to the second pivot pin 124, 122″ and are interleaved with the second plurality of spaced apart hinge eyes 120 extending longitudinally in the second direction.

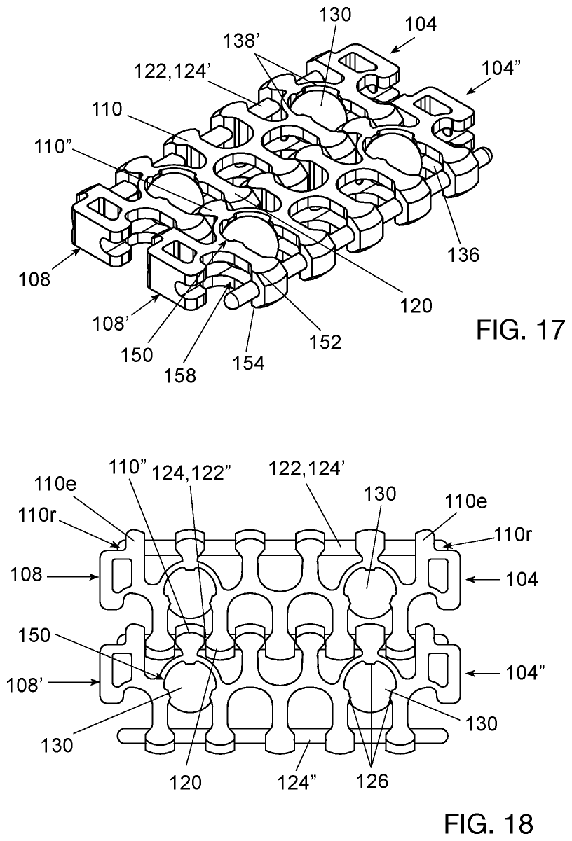

As may be appreciated in FIG. 13, end most hinge eyes 110e are included at opposed ends of the body 108 and have recesses 110r, each of which captures and blocks lateral movement of one of the pivot pin 122. Each of the recesses 110r may include channels that permit cleaning and drainage. After the plurality of spheres 130 have been installed, a pivot pin 122 may be inserted and pushed laterally to connect two adjacent conveyor belt modules. The pivot pin 122 must flex to pass the first end most hinge eye 110e and then must be slid laterally relative to the apertures 114 until the ends become seated in the recesses 110r in the opposed end most hinge eyes 110e. It will be appreciated that installation of a pivot pin 122 connects a first conveyor belt module 104 to another, as shown in FIGS. 17 and 18, and this is effectively repeated successively with each pivot pin 122 serving as a pivot pin 124′ of an adjacent conveyor belt module. Thus, successive conveyor belt modules 104 and pivot pins are installed to construct a modular omnidirectional hygienic conveyor belt.

The respective entries 160 and openings 158 between the upper and lower surfaces 152, 154 of the plurality of U-shaped sphere receiving sockets 150, and the plurality of laterally spaced apart upper and lower arcuate sphere contact surfaces 126, 128 of the respective plurality of the U-shaped sphere receiving sockets 150 provide further access for the hygienic cleaning of the respective body 108, first and second pivot pins 122, 124, and plurality of spheres 130.

In the second example conveyor belt module 104 of the second example modular omnidirectional hygienic conveyor belt the spheres 130 provide integral support of the upper surfaces 152 of the U-shaped sphere receiving sockets 150 relative to the lower surfaces 154 of the U-shaped sphere receiving sockets 150. Also, as with the first example, it will be appreciated that the second example modular omnidirectional hygienic conveyor belt may be configured to run in a straight longitudinal orientation and can be inclined, declined and twisted as needed.

Although the present subject matter is described herein with reference to specific structures, methods and examples, this is for purposes of illustration only, and it is understood that the present subject matter is applicable to a large range of devices that may differ in particular configuration and appearance while still employing this subject matter. This patent is only limited by the appended claims and legal equivalents thereof.

1. A modular omnidirectional hygienic conveyor belt constructed of a series of similar conveyor belt modules that are connected by pivot pins, wherein each conveyor belt module comprises:
a modular laterally extending body having a first plurality of spaced apart hinge eyes extending longitudinally in a first direction to distal ends having laterally extending apertures, a second plurality of spaced apart hinge eyes extending longitudinally in an opposed second direction to distal ends having laterally extending apertures;
wherein the first plurality of spaced apart hinge eyes is laterally offset relative to the second plurality of spaced apart hinge eyes;
wherein the apertures of the first plurality of spaced apart hinge eyes are connected to a first pivot pin;
wherein the apertures of the second plurality of spaced apart hinge eyes are connected to a second pivot pin;
wherein the body further comprises a plurality of laterally spaced apart corresponding sets of upper and lower arcuate sphere contact surfaces located between the first plurality of spaced apart hinge eyes and the second plurality of spaced apart hinge eyes;
a plurality of spheres being disposed between the first and second pivot pins, wherein the plurality of spheres are captured by, engage and rotate omnidirectionally relative to the upper and lower arcuate sphere contact surfaces; and
wherein the plurality of upper and lower arcuate sphere contact surfaces define for the respective plurality of spheres openly exposed opposed upper and lower spherical cap regions and openly exposed spherical segment regions therebetween, wherein openings in the body provide access for hygienic cleaning of the respective body, first and second pivot pins and plurality of spheres.

2. The modular omnidirectional hygienic conveyor belt of claim 1, wherein the first pivot pin has an axis and the second pivot pin has an axis that is parallel to the axis of the first pivot pin.

3. The modular omnidirectional hygienic conveyor belt of claim 1, wherein the first pivot pin is rotatably connected to the first plurality of spaced apart hinge eyes and the second pivot pin is rotatably connected to the second plurality of spaced apart hinge eyes.

4. The modular omnidirectional hygienic conveyor belt of claim 1, wherein the each of the plurality of sets of the upper arcuate sphere contact surfaces is circumferentially spaced apart and defines openings therebetween and each of the corresponding plurality of sets of the lower arcuate sphere contact surfaces is circumferentially spaced apart and defines openings therebetween.

5. The modular omnidirectional hygienic conveyor belt of claim 1, wherein the body includes an end most hinge eye at one end that acts to capture and block lateral movement of one of the pivot pins.

6. The modular omnidirectional hygienic conveyor belt of claim 5, wherein the end most hinge eye at one end includes a recess that acts to capture and block lateral movement of one of the pivot pins.

7. The modular omnidirectional hygienic conveyor belt of claim 1, wherein the body, first and second pivot pins, and plurality of spheres are constructed of one or more plastic materials.

8. The modular omnidirectional hygienic conveyor belt of claim 7, wherein the one or more plastic materials include acetal or polyoxymethylene, polypropylene or polyethylene.

9. The modular omnidirectional hygienic conveyor belt of claim 1, wherein the first pivot pin for each conveyor belt module also serves as a second pivot pin for an adjacent similar conveyor belt module disposed longitudinally in the first direction and the second pivot pin for each conveyor belt module also serves as a first pivot pin for an adjacent similar conveyor belt module disposed longitudinally in the second direction.

10. The modular omnidirectional hygienic conveyor belt of claim 9, wherein the plurality of spaced apart hinge eyes of the respective adjacent similar conveyor belt modules that are connected to a common pivot pin are interleaved.

11. The modular omnidirectional hygienic conveyor belt of claim 1, wherein the spheres provide integral support of the upper arcuate sphere contact surfaces relative to the lower arcuate sphere contact surfaces.

12. The modular omnidirectional hygienic conveyor belt of claim 1, wherein the modular conveyor belt is configured to run in a straight longitudinal orientation and can be inclined, declined and twisted as needed.

13. The modular omnidirectional hygienic conveyor belt of claim 1, wherein the body further comprises driven portions located between the plurality of laterally spaced apart upper and lower arcuate sphere contact surfaces.

14. The modular omnidirectional hygienic conveyor belt of claim 13, further in combination with a plurality of rotatable drive sprockets having drive surfaces that engage driven surfaces located on the conveyor belt modules between the spheres to drive the modular conveyor belt in a first or opposed second direction.

15. The modular omnidirectional hygienic conveyor belt of claim 14, wherein the plurality of rotatable drive sprockets has the drive surfaces on projections that are positioned to engage the driven surfaces on the conveyor belt modules.

16. The modular omnidirectional hygienic conveyor belt of claim 1, further in combination with a directional control system that controls the direction of the omnidirectional rotation of a selected group of the plurality of spheres.

17. The modular omnidirectional hygienic conveyor belt of claim 16, wherein the directional control system further comprises a drive surface that engages the lower spherical cap regions of the selected group of the plurality of spheres.

18. The modular omnidirectional hygienic conveyor belt of claim 17, wherein the drive surface of the directional control system is directionally repositionable.

19. The modular omnidirectional hygienic conveyor belt of claim 18, wherein the drive surface of the directional control system is controlled to move or stop.

20. The modular omnidirectional hygienic conveyor belt of claim 1, wherein the body further comprises:
an upper web comprising:
a laterally extending central portion having a plurality of laterally spaced and connected rings comprising the upper arcuate sphere contact surfaces and upper portions of the first plurality of spaced apart hinge eyes extending longitudinally in the first direction and upper portions of the second plurality of spaced apart hinge eyes extending longitudinally in the opposed second direction;
a lower web comprising:
a laterally extending central portion having a plurality of laterally spaced and connected rings comprising the lower arcuate sphere contact surfaces and lower portions of the first plurality of spaced apart hinge eyes extending longitudinally in the first direction and lower portions of the second plurality of spaced apart hinge eyes extending longitudinally in the opposed second direction;
wherein apertures of the upper portions of the first plurality of spaced apart hinge eyes of the upper web and apertures of the lower portions of the first plurality of spaced apart hinge eyes of the lower web are laterally interleaved and connected to the first pivot pin;
wherein apertures of the upper portions of the second plurality of spaced apart hinge eyes of the upper web and apertures of the lower portions of the second plurality of spaced apart hinge eyes of the lower web are laterally interleaved and connected to the second pivot pin;
wherein the plurality of laterally spaced and connected rings of the upper web are spaced above the plurality of laterally spaced and connected rings of the lower web;
wherein the plurality of spheres is disposed between and engage the upper and lower arcuate sphere contact surfaces and laterally align the plurality of rings of the upper and lower webs.

21. The modular omnidirectional hygienic conveyor belt of claim 20, wherein each upper and lower web includes one hinge eye that captures and blocks lateral movement of one of the pivot pins in one direction.

22. The modular omnidirectional hygienic conveyor belt of claim 20, wherein the upper and lower webs further comprise stops that limit relative movement of the upper and lower webs toward each other.

23. The modular omnidirectional hygienic conveyor belt of claim 1, wherein the body further comprises:
a plurality of laterally spaced U-shaped sphere receiving sockets open in a longitudinal direction;
the plurality of U-shaped sphere receiving sockets having upper and lower surfaces with openings therebetween, and including the plurality of laterally spaced apart upper and lower arcuate sphere contact surfaces;
wherein the U-shaped sphere receiving sockets receive the plurality of spheres when the U-shaped sphere receiving sockets are temporarily flexed to widen an entry to the plurality of laterally spaced apart upper and lower arcuate sphere contact surfaces;
wherein the first pivot pin for each conveyor belt module also serves as a second pivot pin for an adjacent similar conveyor belt module disposed longitudinally in the first direction, such that the second plurality of spaced apart hinge eyes extending longitudinally in an opposed second direction from the body of a similar conveyor belt module are connected to the first pivot pin and are interleaved with the first plurality of spaced apart hinge eyes extending longitudinally in the first direction;
wherein the second pivot pin for each conveyor belt module also serves as a first pivot pin for an adjacent similar conveyor belt module disposed longitudinally in the second direction, such that the first plurality of spaced apart hinge eyes extending longitudinally in an opposed first direction from the body of a similar conveyor belt module are connected to the second pivot pin and are interleaved with the second plurality of spaced apart hinge eyes extending longitudinally in the second direction; and
wherein the openings between the upper and lower surfaces of the plurality of U-shaped sphere receiving sockets and the plurality of laterally spaced apart upper and lower arcuate sphere contact surfaces of the respective plurality of the U-shaped sphere receiving sockets provide the access for the hygienic cleaning of the respective body, first and second pivot pins, and plurality of spheres.
